(19) United States
(12) Patent Application Publication
(10) Pub. No.: US 2023/0222021 A1
(43) Pub. Date: Jul. 13, 2023

(54) ANY-TO-ANY APPLICATION PROGRAMMING INTERFACE CONNECTOR SYSTEM FOR INFORMATION EXCHANGE PLATFORM

(71) Applicant: OPEN TEXT GXS ULC, Halifax (CA)

(72) Inventors: Waqas Ahmed, Clarksburg, MD (US); Jeffrey Hamilton, Antioch, TN (US); Saravanan Palanisamy, Bangalore (IN)

(21) Appl. No.: 17/957,968

(22) Filed: Sep. 30, 2022

Related U.S. Application Data
(63) Continuation of application No. 17/957,412, filed on Sep. 30, 2022.

(30) Foreign Application Priority Data
Jan. 10, 2022 (IN) 202241001267

(51) Int. Cl. G06F 9/54

(52) U.S. Cl. CPC G06F 9/547; G06F 9/541; G06F 9/542

(57) ABSTRACT

An any-to-any (A2A) connector system provides an A2A integration framework that includes an ingress router, a connector system, and enhancements to an orchestration service framework of an information exchange platform. At design time, an application programming interface (API) connector can be generated based on API documentation for the external service. At runtime, in processing an itinerary that includes a universal service, the external service is called through the universal service using the API connector. The universal service is operable to parse a request from a client system, query a connector database, and, based on a result from the connector database, sends a request to a connector engine. The connector engine fetches the API connector from the connector database, calls the external service using the API connector, handles results of the call, and returns the results to the universal service.

### CROSS-REFERENCE TO RELATED APPLICATION(S)

This application is a continuation of, and claims a benefit of priority from, U.S. patent application Ser. No. 17/957,412, filed Sep. 30, 2022, entitled “ANY-TO-ANY APPLICATION PROGRAMMING INTERFACE CONNECTOR SYSTEM FOR INFORMATION EXCHANGE PLATFORM,” which claims a benefit of priority under 35 U.S.C. § 119(a) from Indian Patent Application No. 202241001267, filed Jan. 10, 2022, entitled “ANY-TO-ANY APPLICATION PROGRAMMING INTERFACE CONNECTOR SYSTEM FOR INFORMATION EXCHANGE PLATFORM,” both of which are fully incorporated by reference herein for all purposes.

### TECHNICAL FIELD

This disclosure relates generally to data processing in a network computing environment. More particularly, this disclosure relates to an any-to-any application programming interface (API) connector system with reusable API connectors and an any-to-any ingress router, useful for connecting an information exchange platform with third-party service provider systems.

### BACKGROUND OF THE RELATED ART

Today, enterprises and entities alike recognize the tremendous cost savings by exchanging business documents such as purchase orders, invoices, etc. with their trading partners using enterprise-to-enterprise electronic data interchange platform such as an information exchange platform. Generally, an information exchange platform operates in a network environment and has the necessary resources (e.g., hardware, software, personnel, etc.) to provide managed services that enable the real-time flow or exchange of information electronically in the network environment in a secure, fast, and reliable manner, between and among disparate entities (also referred to herein as operating units).

Examples of such operating units may include enterprises, corporations, companies, agencies, etc. An example of a network environment may include a distributed computer network, a cloud computing environment, or the Internet. Non-limiting examples of managed services may include translation services, format services, copy services, email services, document tracking services, messaging services, document transformation services (for consumption by different computers), regulatory compliance services (e.g., legal hold, patient records, tax records, employment records, etc.), encryption services, data manipulation services (e.g., validation), etc.

An information exchange platform operates to facilitate the real-time flow or exchange of information between disparate entities regardless of standards preferences, spoken languages, or geographic locations. An information exchange platform may be embodied on server machines that support electronic communication methods used by various computers that are independently owned and operated by different entities. In some embodiments, supported data formats may include standardized electronic data interchange (EDI), Extensible Markup Language (XML), RosettaNet, EDI-INT, flat file/proprietary format, etc. Supported network connectivity may include dial-up, frame relay, AS2, leased line, Internet, etc. Supported delivery methods may include store-and-forward mailbox, event-driven delivery, etc. Supported transport methods may include Hypertext Transfer Protocol (HTTP), File Transfer Protocol (FTP), and Simple Mail Transfer Protocol (SMTP), etc. Supported network security protocols may include Secure Socket Layer (SSL), Secure/Multipurpose Internet Mail Extensions (S/MIME), Internet Protocol Security (IPSEC), Virtual Private Network (VPN), Pretty Good Privacy (PGP) encryption protocol, etc.

In some cases, an information exchange platform may leverage services provided by third parties, for instance, online shopping services, delivery services, business management services, enterprise operation services, etc. Typically, manual coding is required to set up each third-party service provider system with the information exchange platform so that a custom API call can be made to a respective third-party service provider system.

Further complicating the manual coding effort is the nature of enterprise-to-enterprise electronic data exchange, as different operating units may have different sets of requirements that must be met. For example, an operating unit may require that all incoming documents must be in English, validated, and encrypted. Suppose validation is provided by a third-party validation server. This means that a programmer writing code to set up the information exchange platform to call the third-party validation server must consider how the information exchange platform is to process a document sent by another operating unit into the required language, call the third-party validation server, get a validated document back from the third-party validation server, and apply an encryption on the validated document.

As the number of third-party service providers continues to grow, this manual coding solution becomes impractical, time consuming, and unmanageable. Consequently, there is a need for a scalable solution in integrating an information exchange platform with third-party services. Embodiments disclosed herein can address this need and more.

### SUMMARY OF THE DISCLOSURE

A goal of this disclosure is to provide a scalable and efficient solution for an information exchange platform to integrate with third-party services. This goal is realized in an any-to-any (A2A) connector system that can minimize or eliminate manual coding efforts needed to integrate third-party services provided by external and/or third-party service provider systems. In some embodiments, the A2A connector system provides an A2A integration framework that includes an ingress router, a connector system, and enhancements to an orchestration service framework that is part of the information exchange platform.

In some embodiments, a method for third-party service integration can include, at design time, generating, based on application programming interface (API) documentation associated with an external service, an API connector for the external service. The external service is provided by a third-party service provider system communicatively connected to the information exchange platform over a network. At runtime, in processing an itinerary that includes a universal service, the external service can be called through the universal service using the API connector. In some embodiments, the universal service is operable to obtain a customer identifier from the itinerary, obtain an object identifier from a data object contained in a request from a client system of the information exchange platform, query a connector database using the customer identifier and the object identifier, and, based on a result from the connector database, sends a request to a connector engine. In some embodiments, the connector engine is operable to, based on the request from the universal service, fetch the API connector from the connector database, call the external service using the API connector, handle results of the call, and return the results to the universal service.

In some embodiments, processing of the itinerary can be triggered by the arrival of a file from the client system. In some embodiments, the itinerary can be determined by an ingress router based on a sender of the file, a receiver of the file, and a document type of the file. In some embodiments, the ingress router may pass information about the file and control of the itinerary to an orchestration engine of the information exchange platform. The itinerary can include one or more managed services provided by backend system(s) of the information exchange platform, as well as external service(s) provided by third-party service provider system(s). In this case, processing of the itinerary is orchestrated by the orchestration engine of the information exchange platform.

In some embodiments, a connector catalog can be provided through a user interface. The connector catalog contains API connectors previously built and stored in the connector database. Each API connector contains details of an API particular to an external service.

In some embodiments, a connector building tool can be used for building an API connector for a particular external service. The connector building tool can include a user interface with an input field for providing a link or address to the API documentation associated with the external service.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. The features illustrated in the drawings are not necessarily drawn to scale.

FIG. 1 depicts a diagrammatic representation of an example of an information exchange platform.

FIG. 2 illustrates an example of an itinerary that includes managed services provided by an information exchange platform.

FIG. 3 illustrates an example of how third-party service providers may connect to an information exchange platform.

FIG. 4 provides an example of manual coding efforts typically required in integrating an external third-party service with an itinerary orchestrated through an information exchange platform.

FIG. 5 depicts a diagrammatic representation of an example of an A2A connector system with an A2A integration framework that includes an ingress router, a connector system, and enhancements to an orchestration service framework that is part of the information exchange platform according to some embodiments disclosed herein.

FIG. 6 depicts a diagrammatic representation of how a streamlined process disclosed herein can alleviate technical challenges in third-party service integration efforts according to some embodiments disclosed herein.

FIG. 7 illustrates an example of a connector system according to some embodiments disclosed herein.

FIG. 8 illustrates an example of ingress router according to some embodiments disclosed herein.

FIG. 9 illustrates an example of a universal service working in concert with a connector engine according to some embodiments disclosed herein.

FIG. 10 depicts a diagrammatic representation of a user interface of a connector building tool according to some embodiments disclosed herein.

FIG. 11 illustrates an example of how an API connector can be generated for an external service called by an orchestration engine according to some embodiments disclosed herein.

FIG. 12 depicts a diagrammatic representation of a distributed network computing environment where embodiments disclosed can be implemented.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

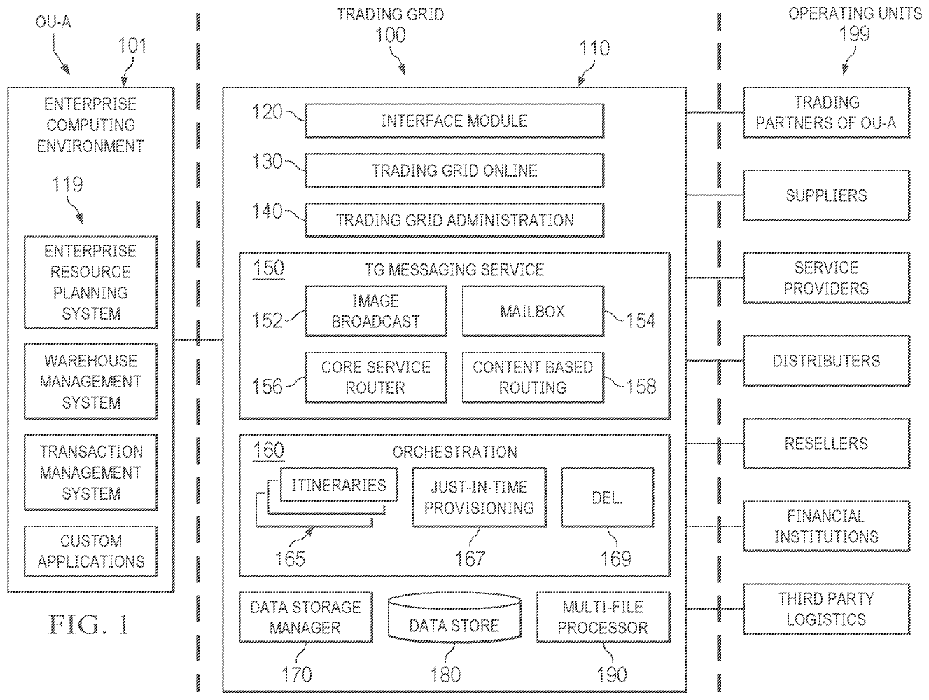

Embodiments disclosed herein provide an any-to-any (A2A) connector system for an information exchange platform. FIG. 1 depicts a diagrammatic representation of an example information exchange platform, referred to as Trading Grid 100, operating in a computer network environment. Non-limiting examples of Trading Grid system architecture, implementations, and features can be found in U.S. Pat. No. 10,346,802, entitled “TRADING PARTNER RELATIONSHIP GRAPH FOR INFORMATION EXCHANGE PLATFORM,” and U.S. Pat. No. 10,771,591, entitled “JUST-IN-TIME AUTO-PROVISIONING SYSTEMS AND METHODS FOR INFORMATION EXCHANGE PLATFORM,” both of which are incorporated by reference herein.

In the example shown in FIG. 1, system 110 operating on Trading Grid 100 may comprise a plurality of modules, including interface module 120, Trading Grid Online (TGO) 130, Trading Grid Administration (TGA) 140, Trading Grid Messaging Service (TGMS) 150, Orchestration Engine 160, and Data Storage Manager (DSM) 170. In some embodiments, system 110 may be configured to provide and manage (orchestrate) a very large number (e.g., 50 or more) of services, referred to herein as “managed services.” Interface module 120 may be configured to provide user interfaces for registered operating units (OUs) such as OU-A with access to these managed services.

As an example, OU-A may own and operate enterprise computing environment 101 which is separate and independent of Trading Grid 100. From the perspective of Trading Grid 100 or system 110, OU-A is an enterprise customer and systems 119 of OU-A, which utilize managed services provided by system 110, are client systems of system 110. Client systems 119 operating in enterprise computing environment 101 may use managed services to communicate (e.g., exchange information) with various systems and/or devices operating in computing environments 199 that are owned and operated by various OUs such as trading partners (TPs) of OU-A.

Non-limiting examples of managed services provided by system 110 may include, but are not limited to, translation services, format services, copy services, email services, document tracking services, messaging services, document transformation services (for consumption by different computers), regulatory compliance services (e.g., legal hold, patient records, tax records, employment records, etc.), encryption services, data manipulation services (e.g., validation), etc. As a specific example, a document may be sent by OU-A from client system 119 (e.g., a custom application) to a computer belonging to a TP of OU-A utilizing Trading Grid 100.

A “document” in this context refers to the encoding of information in digital form for the purpose of exchanging the information with another party. The encoding of the document may also include metadata about its content, destination, operational parameters, permissions, etc. Examples of documents in this context can include electronic data interchange (EDI)-encoded formats, commonly used word processing formats, computer-aided design and computer-aided manufacturing (CAD/CAM) files, multimedia content including video, and even content that could be provided by a device participating in an Internet of Things (IoT) network. Skilled artisans appreciate that EDI is an electronic communication method that provides standards for exchanging data via any electronic means and that is defined as the computer-to-computer interchange of formatted messages by agreed message standards. EDI distinguishes mere electronic communication or data exchange in that in EDI, the usual processing of received messages is by computer only. By adhering to the same message standard, TPs, even if they are in two different countries and/or use different native proprietary data formats, can electronically exchange documents (e.g., purchase orders, invoices, acknowledgement, notices, etc.).

In some embodiments, TGMS 150 may route the document sent by OU-A from client system 119 through various components for internal processing. For example, Content Based Routing (CBR) module 158 of TGMS 150 may route the document based on a relationship between OU-A (sender) and a TP of OU-A (receiver) and a document type (Doc Type) specified in itinerary 165.

In some embodiments, system 110 may track, via a trading partner graph, all the relationships for some or all OUs that utilize system 110 to electronically exchange information. The trading partner graph may be maintained and controlled by system 110 independently of an operating unit and/or its trading partner(s). The trading partner graph may be stored in a database (e.g., data store 180) and system 110 may access the trading partner graph by querying the database. Data associated with the operating unit and its trading partner(s) may also be stored in the database. Details and examples of a trading partner graph can be found in the above-referenced U.S. Pat. No. 10,346,802, entitled “TRADING PARTNER RELATIONSHIP GRAPH FOR INFORMATION EXCHANGE PLATFORM.”

In some embodiments, Orchestration Engine 160 may process the document based on itinerary 165. As an example, itinerary 165 may indicate that the document is to be processed by decompression, translation, formatting, and validation services. Delivery component 169 may deliver the document thus processed to the receiver (a TP of OU-A). In some embodiments, multiple itineraries 165 can be associated with the same pair of sender-receiver, depending upon the Doc Type associated with the document to be processed and delivered.

In some cases, not all OUs may be enterprise customers of system 110, although they may be communicatively connected to Trading Grid 100, as illustrated in FIG. 1. For example, system 110 may be configured for communicating with non-customer OUs over SMTP. Skilled artisans appreciate that SMTP is an Internet standard for electronic mail (email) transmission. This allows system 110 to deliver a processed document to a non-customer OU, for instance, as an attachment to an email. In some embodiments, in making a delivery, system 110 may create an email on behalf of one of its enterprise customers so that the email appears to have come directly from a partner of the non-customer OU and the non-customer OU is unaware of the processing performed on the document by system 110.

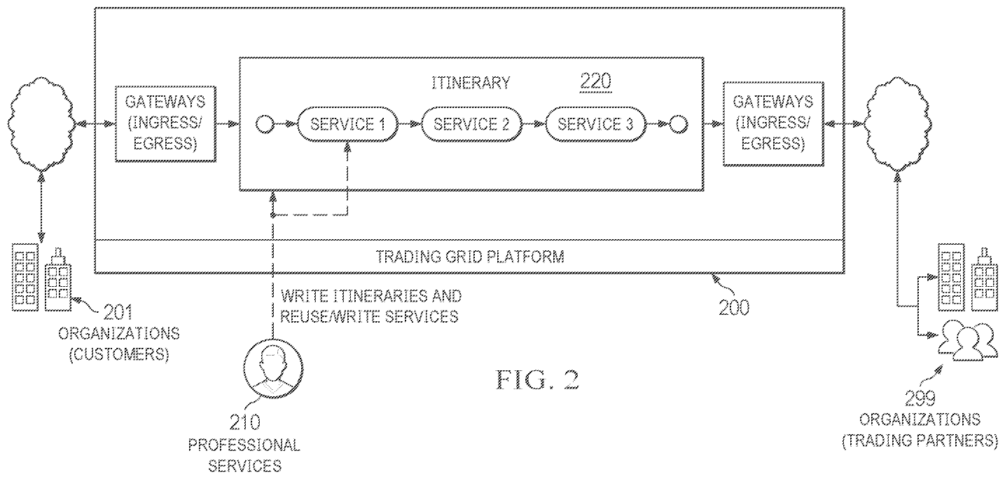

There are many ways to provision enterprise customers. For example, a representative of system 110 (e.g., as part of professional services 210 shown in FIG. 2) may reach out and engage with a customer (e.g., customer 201 shown in FIG. 2), get certain information set from the customer (e.g., who they are, how to communicate with them, etc.), and use some internal tools that interact (e.g., via APIs) with provisioning services to configure a custom workflow solution for the customer. However, some customers may have a large number (e.g., 500 to 1000 or more) of TPs with technologically sophisticated systems including their own gateways, technology structures, internal processes, etc. Therefore, creating and managing such workflow solutions can be technically complex, complicated, and challenging.

In this disclosure, a custom workflow solution can be considered a grouping mechanism for identity uniqueness within a boundary or scope for a TP. System 110 provides a set of data flows within this boundary to address a problem space for that TP. Each custom workflow solution can be identified through a solution identifier (ID) in system 110.

As illustrated in FIG. 2, a custom workflow solution for a customer 201 may include an itinerary 220. As discussed above, an itinerary may indicate how a document from a sender (e.g., customer 201 or its TPs 299) is to be processed by a set of services (e.g., decompression, translation, formatting, validation, etc.). The logical relationships between customer 201 and all of its TPs 299 may be represented in a graph of TP connections referred to as a TP graph. The TP graph may be stored in a database (e.g., data store 180).

In some cases, a data flow can be triggered by the arrival of a file (e.g., an invoice). A receive process may operate to determine an itinerary based on the sender (e.g., the invoice comes from a particular client of the Trading Grid), the receiver (e.g., a particular email address), and a particular Doc Type. This specific combination of Sender, Receiver, and Doc Type indicates to the receive process that it needs to execute a certain itinerary. Referring to FIG. 1, in some embodiments, Orchestration Engine 160 may control the processing of this itinerary automatically as triggered by the arrival of the invoice.

In some cases, a data flow may utilize a set of attributes. Examples of such attributes may include a receiver address (e.g., “Address”=“XYZ”) that belongs to a mailbox (e.g., “Mailbox”=“ma12”) and a Doc Type value (e.g., “Doc Type”=“X”) configured from a particular workflow perspective (because different Doc Types may be applicable for different workflows). Some attributes may be highly critical to downstream processes (e.g., receiver address, sender address, and Doc Type, which are core tuple attributes).

As a non-limiting example, tuples can be implemented in functional programing languages as a set of particular attributes (e.g., Sender, Receiver, Doc Type) with values that can be passed from one program to another. In this context, a tuple may also be referred to as a data flow tuple. Tuples may be defined for a client system, trading partner, Doc Type, direction, or solution ID. Each data flow is specific to how a managed service is to be performed for a particular client system (e.g., client system 119 of OU-A, a client of Trading Grid 100), for instance, sending a purchase order on behalf of Entity A to its trading partner, Entity N. A tuple can have globally unique attributes and be associated with an itinerary. In some embodiments, an itinerary can be an XML document that describes a processing model for processing a particular Doc Type. For example, processing a certain type of document may require performing a set of managed services on the document (e.g., translation services, format services, copy services, email services, document tracking services, messaging services, document transformation services, regulatory compliance services, encryption services, data manipulation services, or a combination thereof).

In some cases, every data flow can have a Sender, a Receiver, and a Doc Type so that different processing models can be performed for different purposes even for relationships that exist between the same two partners. For example, enterprise A trades with TP B. Enterprise A has an address and TP B has an address. They may transact multiple document types as part of that relationship. Doc Types allows the Trading Grid to differentiate different processing needs in this relationship. For example, different managed services may be needed to process a purchase order and an advanced ship notice, but they may be exchanged between the same partners using the same addresses, and even in the same directions.

The workflow attributes are returned to the orchestration component (e.g., Orchestration Engine 160 shown in FIG. 1) that initiated this whole process. In some cases, the orchestration component may operate to create a file set that has a new tuple for a newly provisioned TP (the receiver with the particular email address in this example). The tuple is passed to another service (e.g., multi-file processor 190 shown in FIG. 1) which takes the information contained in the tuple and determines what itinerary needs to be executed for that particular tuple. In some cases, the multi-file processor may reach out to CBR 158 to find what itinerary needs to be executed based on Sender, Receiver, and Doc Type.

In some embodiments, such a “file set” (which is automatically created by the orchestration component using the output from an auto-provisioning process) may represent an operational data model that can be used to describe files and their tuple associations. A file set can often be used in translation where a single input file may have 5, 10, or a thousand output files. It is an expandable model in which each file would have an individual Sender, Receiver, and Doc Type association. Following the example above in which a non-legal invoice was received from a client to the client's TP and triggers an auto-provisioning process to set up the client's TP in the Trading Grid, when the auto-provisioning process is complete, a file set is generated for the client's TP by the orchestration component. Multi-file processor 190 gets the file set generated for the client's TP from the orchestration component with a sender address, a newly created receiver address, and a Doc Type and finds an itinerary that represents all the activities (services) needed to process the invoice. Multi-file processor 290 then sends the itinerary back to Orchestration Engine 160 with the name of the itinerary for execution by the orchestration component (e.g., as part of a receive process).

In the example of FIG. 2, itinerary 220 for processing the document from the sender may include managed services internal to an information exchange platform (e.g., Trading Grid Platform 200). As a non-limiting example, a file received by a Trading Grid (e.g., Trading Grid 100) from a backend system may contain a document such as an invoice. Electronic invoicing (also called e-invoicing) is a form of electronic billing. E-invoicing methods are used by trading partners, such as enterprises and their suppliers, to present and monitor transactional documents between one another and ensure the terms of their trading agreements are being met. These documents can include invoices, purchase orders, debit notes, credit notes, payment terms and instructions, remittance slips, and so on.

An e-invoice can be defined as structured invoice data issued in EDI or XML formats, for instance, using Internet-based web forms. These documents can be exchanged in a number of ways including EDI, XML, or comma-separated values (CSV) files. They can be provided to the Trading Grid in many ways (e.g., via emails, web applications, FTP calls, API calls, etc.).

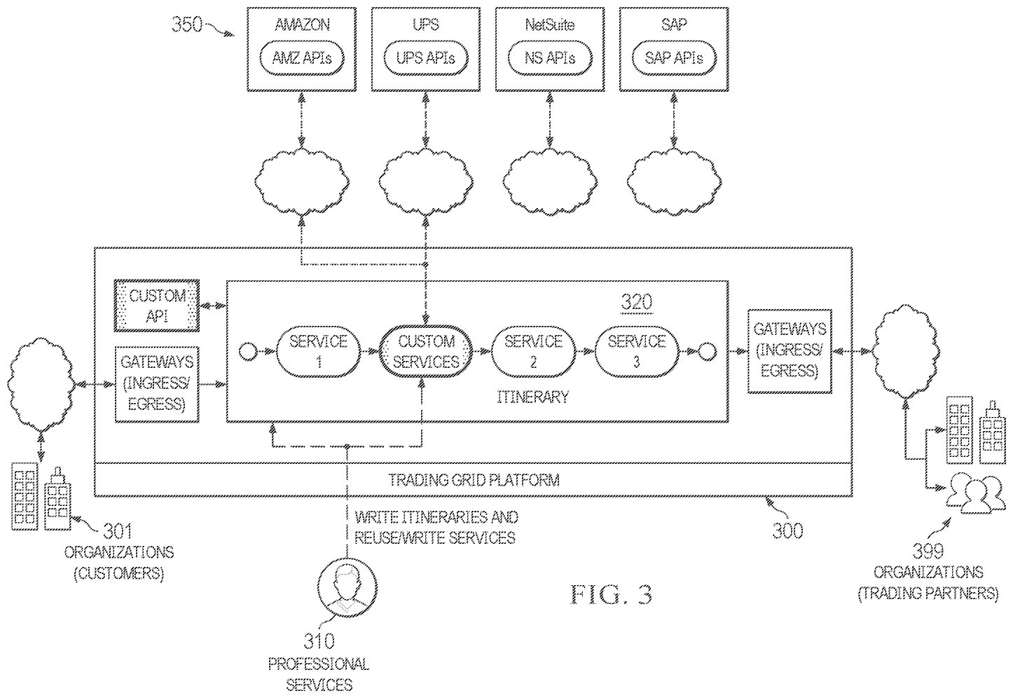

In some jurisdictions, such as Europe and South America, an electronic invoice may not be recognized unless it is a legal invoice. This means that, at the time the invoice was received by the Trading Grid, the electronic invoice was not yet a legal invoice. Since it can be important to meet e-invoicing standards in some jurisdictions, the Trading Grid may leverage external e-invoicing service(s) such as the Active Invoice and Compliance (AIC) service so that the invoice received by the Trading Grid from the backend system can be processed, signed by an appropriate certificate, and delivered (e.g., via push delivery) as a legal invoice (e.g., a signed invoice in the Portable Document Format (PDF)). That is, in addition to managed services internal to the Trading Grid, an itinerary can include external service(s) provided by third parties. This is further illustrated in FIG. 3.

As illustrated in FIG. 3, in some cases, integration with services provided externally by third-party service providers may be necessary. For example, an enterprise customer may hire an operator (e.g., via professional services 310) of an information exchange platform (e.g., Trading Grid Platform 300) to build an integration layer for the enterprise. A customer system 301 may send Trading Grid Platform 300 an “Order” object as payload intended for one of its TPs 399. Trading Grid Platform 300 may receive this object via an API, then implements an itinerary 320 that includes a plurality of services, including managed services (e.g., Service 1, Service 2, Service 3) provided by Trading Grid Platform 300 and third-party services (e.g., Custom Services) provided by third-party service provider systems (e.g., third-party service provider systems 350) such as an online shopping platform, a courier service platform, etc. Trading Grid Platform 300 may extract an order identifier from the object and call third-party service provider systems 350 with Order details and shipment details, respectively.

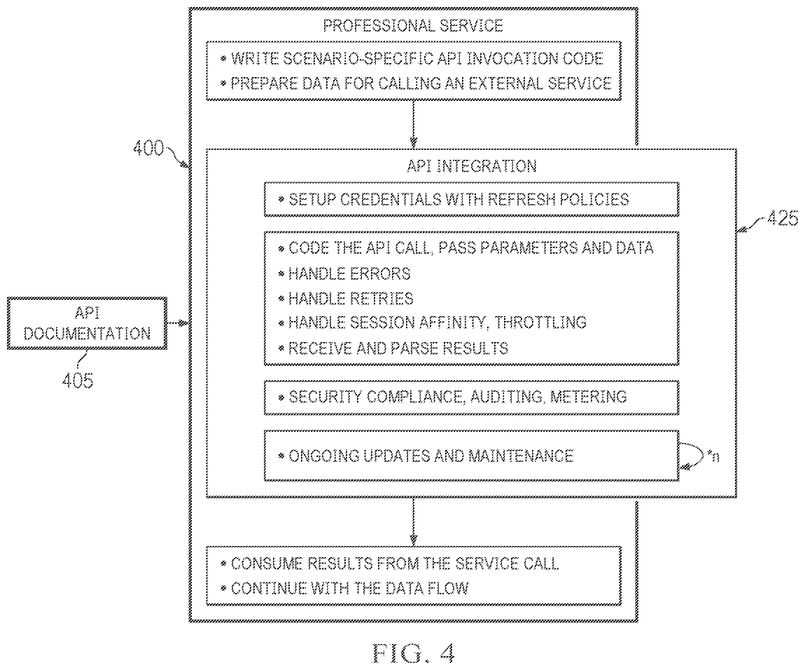

This kind of integration with third-party service provider systems can be technically complex, procedurally challenging, and time-consuming as it usually involves a huge amount of manual coding. FIG. 4 provides an example of manual coding efforts typically required in integrating an external third-party service with an itinerary.

Specifically, each third-party service may come with its own API and corresponding API documentation 405. As part of a professional service 400, integrating with such a third-party service requires writing scenario-specific API invocation code, preparing data for making an API call to the third-party service, configuring an API integration 425, consuming results from the service call, and then continuing with the flow. As the number of APIs increases, so does the number of code objects that need to be maintained and kept secure. Potentially, inconsistent and insecure practices may creep in from a large number of developers invoking APIs. As the number of third-party services continues to grow, complex and costly update cycles can also make accommodating changes in these APIs very challenging. Further, even when the only differences among some external services are parameters and credentials, API invocation code has to be written individually for respective external services and workflows. Accordingly, this type of manual coding effort is inefficient and not scalable.

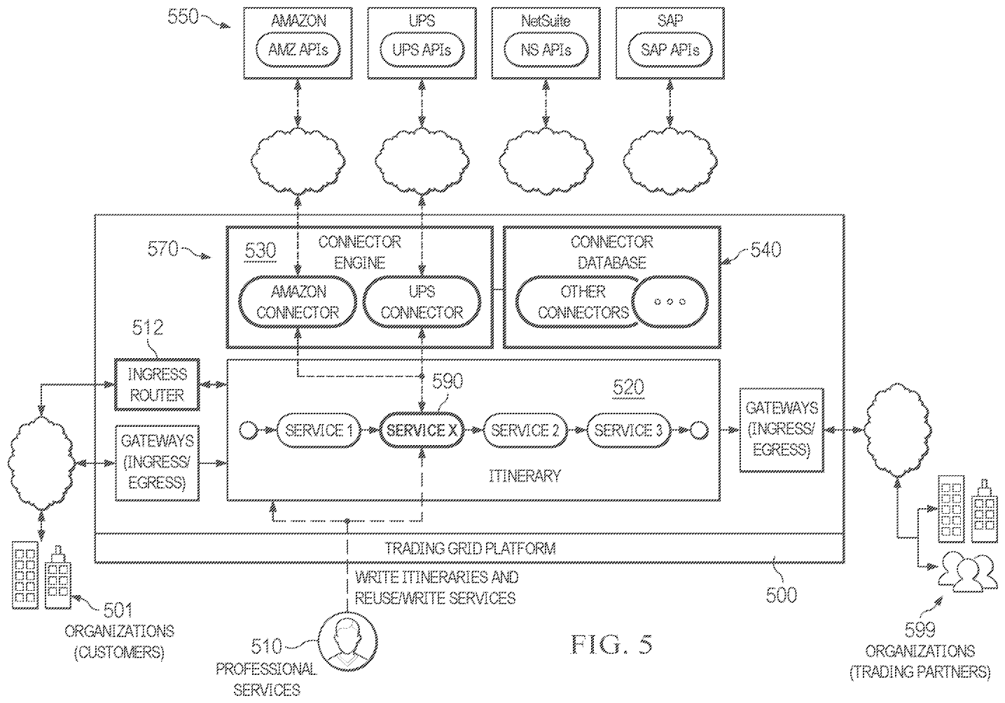

In this context, a goal of the invention disclosed herein is to minimize or eliminate manual coding efforts needed to integrate third-party services provided by external and/or third-party service provider systems. In embodiments disclosed herein, this goal is achieved in an any-to-any (A2A) connector system, an example of which is illustrated in FIG. 5.

As exemplified in FIG. 5, an A2A connector system 500 provides an A2A integration framework that includes an ingress router 512, a connector system comprising a connector engine 530 and a connector database 540, and enhancements to an orchestration service framework that is part of Trading Grid Platform 500. Similar to Trading Grid Platforms 100, 200, and 300, Trading Grid Platform 500 enables client systems (e.g., those associated with customers 501) to exchange information with their TPs (e.g., via computer systems operating in disparate computing environments 599). The ingress router is adapted for providing an integration entry point for external systems and can be exposed (e.g., accessible by the external systems) as an API.

At design time, an enterprise customer (e.g., customer 501) may hire an operator of an information exchange platform (e.g., Trading Grid Platform 500) to build a workflow solution (e.g., via professional services 510) that includes an itinerary (e.g., itinerary 520). This itinerary may include a plurality of services, including managed services (e.g., Service 1, Service 2, Service 3) provided by Trading Grid Platform 500 and external services provided by third-party service provider systems (e.g., third-party service provider systems 550), each having their own proprietary APIs. However, instead of manually integrating with individual APIs provided by third-party service provider systems and then including the external services in the itinerary, a universal service (e.g., Service X 590) is used in the itinerary in place of the external services.

In some embodiments, the universal service is provided by a connector engine (e.g., connector engine 530) which is part of a connector system (e.g., connector system 570) that the information exchange platform leverages to connect with third-party service provider systems in processing itineraries. In the example illustrated in FIG. 5, connector system 570 includes ingress router 512, connector engine 530, and connector database 540. These connector system components are further described below.

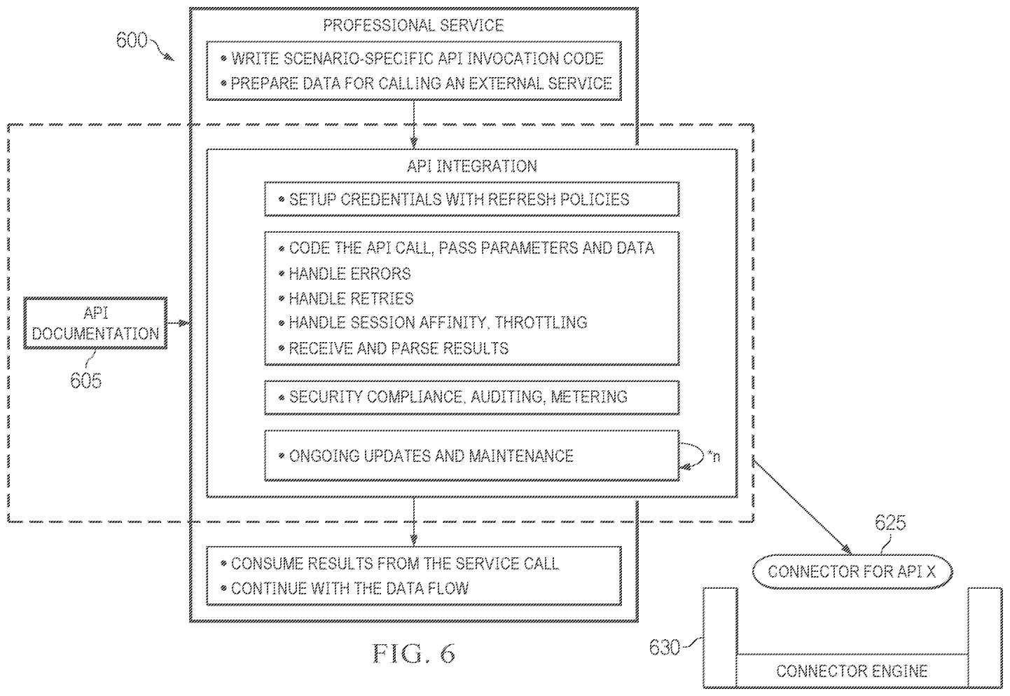

Referring to FIG. 6, instead of writing scenario-specific API invocation code and manually configuring integration with an API provided by a third-party service provider, an API connector (e.g., API connector 625) for connecting to an external service can be built at design time, as part of a professional service 600, based on API documentation 605. The API connector thus generated can be stored in a connector database accessible by a connector engine (e.g., connector engine 630) at runtime.

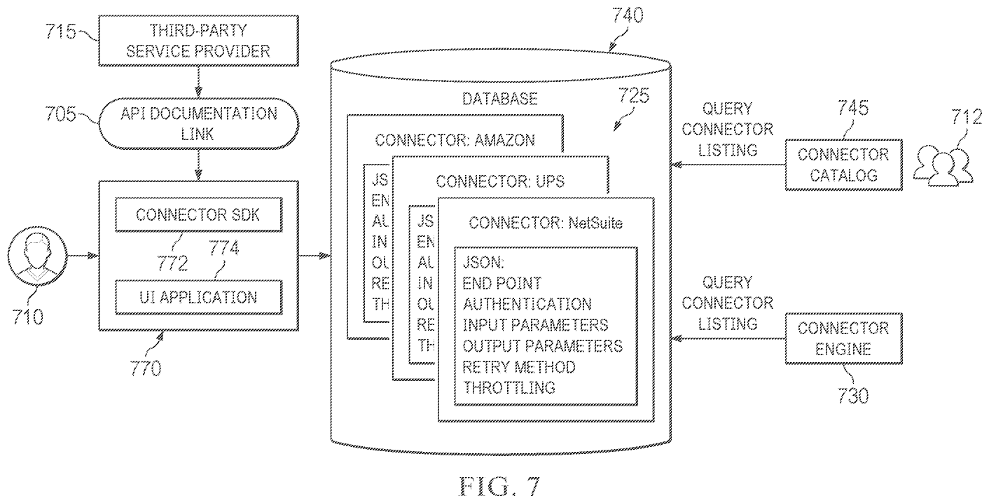

As illustrated in FIG. 7, in addition to the connector engine (e.g., connector engine 730), a connector system 770 can include a connector software development kit (SDK) (e.g., connector SDK 772) and a connector catalog (e.g., connector catalog 745) listing available API connectors (e.g., API connectors 725) stored in a connector database (e.g., connector database 740).

The connector SDK provides a user interface (UI) application (e.g., UI application 774) that can read (e.g., via an API documentation link 705) the API documentation (e.g., API documentation 605) provided by an external service provider (e.g., third-party service provider 715). The API documentation is a connector specification published by the external third-party service provider and includes details on how to connect to a particular external service provided by the third-party service provider via their API. Through the connector SDK, the UI application can generate connector objects (e.g., JSON files containing connector definitions) for an API connector (e.g., API connector 725) particular to the third-party service provider. API connectors thus written can be published or otherwise stored in a connector database (e.g., connector database 740) and made available for use through the connector catalog (e.g., connector catalog 745), sometimes referred to as a connector library.

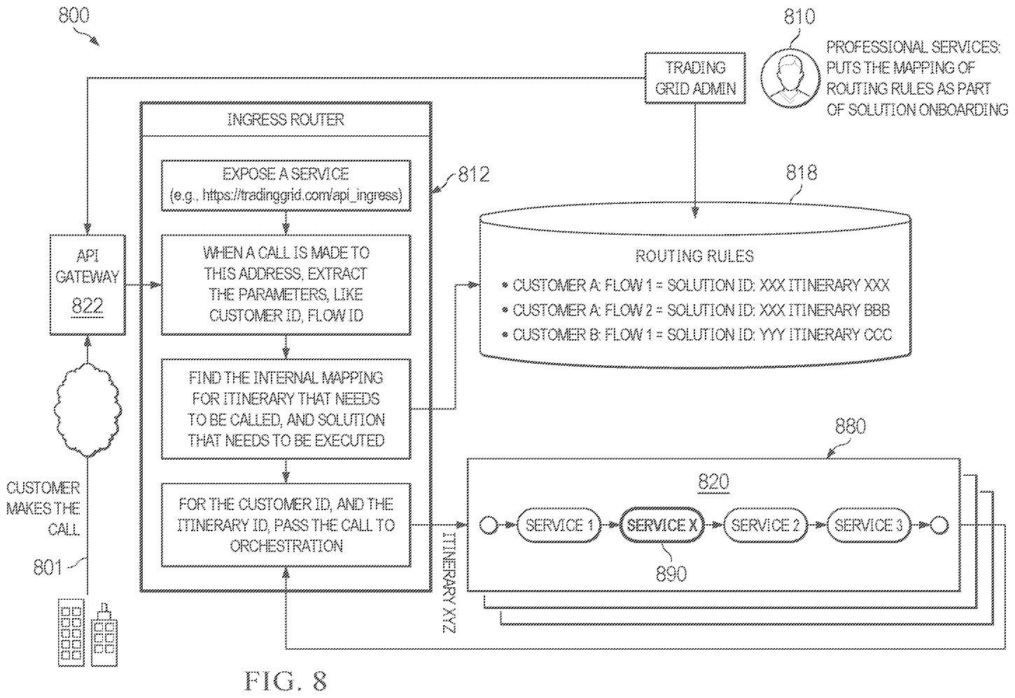

The connector catalog provides a UI view of API connectors published in the connector database. Through the connector catalog, users (e.g., user 712) can view a library of available API connectors to a variety of services provided and/or supported by the information exchange platform. That is, once the API connectors are created from their published documentation at design time, they can be presented in the connector catalog and executed in the connector engine at runtime. The connector engine may, in response to requests from the ingress router (e.g., ingress router 812 shown in FIG. 8), call the external service using the same API connector through the universal service (e.g., Service X 890 shown in FIG. 8) in processing different itineraries (e.g., itineraries 880 shown in FIG. 8). Accordingly, the API connector can be characterized as a reusable API connector.

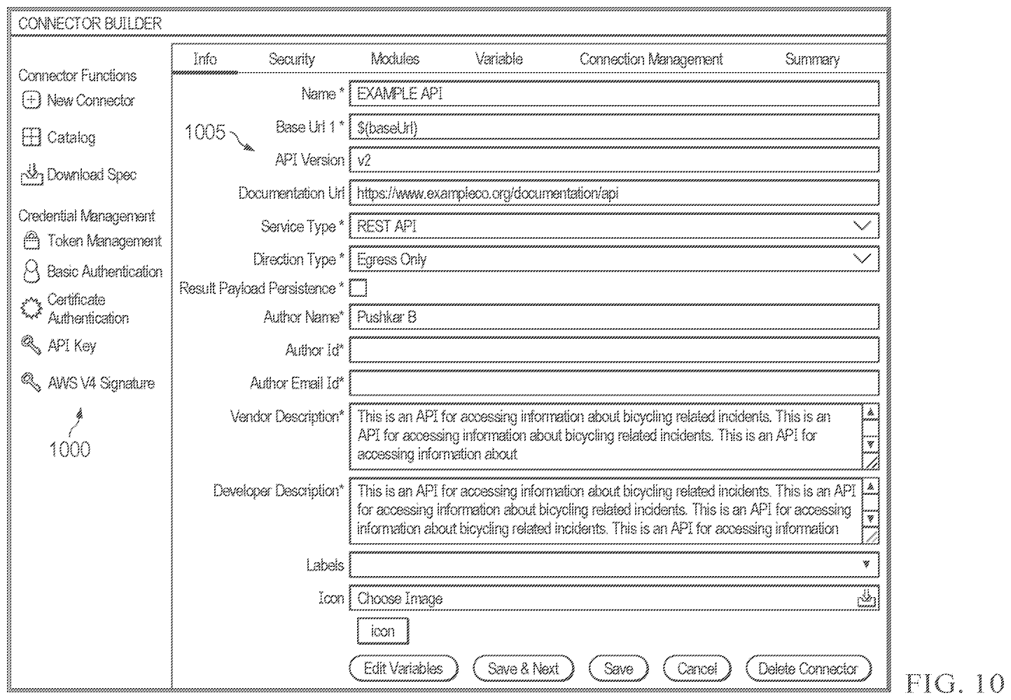

FIG. 10 depicts a diagrammatical representation of a user interface of an example connector building tool (e.g., connector builder 1000) for building reusable API connectors at design time. An authorized user such as an administrator can provide information such as an API documentation link (e.g., API documentation link 1005) to generate a connector definition. Once built, the API connector can be used multiple times, whenever a corresponding third-party service is called.

The connector engine is a runtime component that can execute the logic of the reusable API connector (i.e., calling an external API), for instance, by reading the details of the corresponding API connector from an connector JSON object from the ingress router. There is no need for the manual API integration. As illustrated in FIG. 7, both the connector catalog and the connector engine can query the connector database for a list of available API connectors.

Referring to FIG. 8, as a non-limiting example, in operation of a workflow solution, a customer program running on a client system (e.g., client system 801) may make a call (e.g., https://tradinggrid.com/customerid/itinerary1) to an ingress router (e.g., ingress router 812) through an API gateway (e.g., API gateway 822) of an information exchange platform (e.g., Trading Grid Platform 800). The call may include metadata, such as a customer ID, a flow ID, etc., and a data object (e.g., an Order document). The data object may include an order ID, date, buyer, address, amount, etc.

In some embodiments, the ingress router handles the incoming call, parses it, determines a target itinerary (e.g., itinerary 820) based on information contained in the incoming call and routing rule(s) 818, and sends the information to an orchestration component (e.g., Orchestration Engine 160 shown in FIG. 1) which orchestrates processing of the target itinerary. As illustrated in FIG. 8, the routing rules can be specified by an authorized user or administrator (e.g., via professional services 810) of the information exchange platform.

In some embodiments, inside the target itinerary, a universal service, referred to as ‘Service X’ (e.g., Service X 890), has the necessary function to make the external calls using the appropriate API connectors previously designed. In embodiments disclosed herein, all non-managed services (i.e., external services that are not provided by the information exchange platform) can be called through the universal service which, as illustrated in FIG. 8, can be included in various itineraries (e.g., itineraries 880).

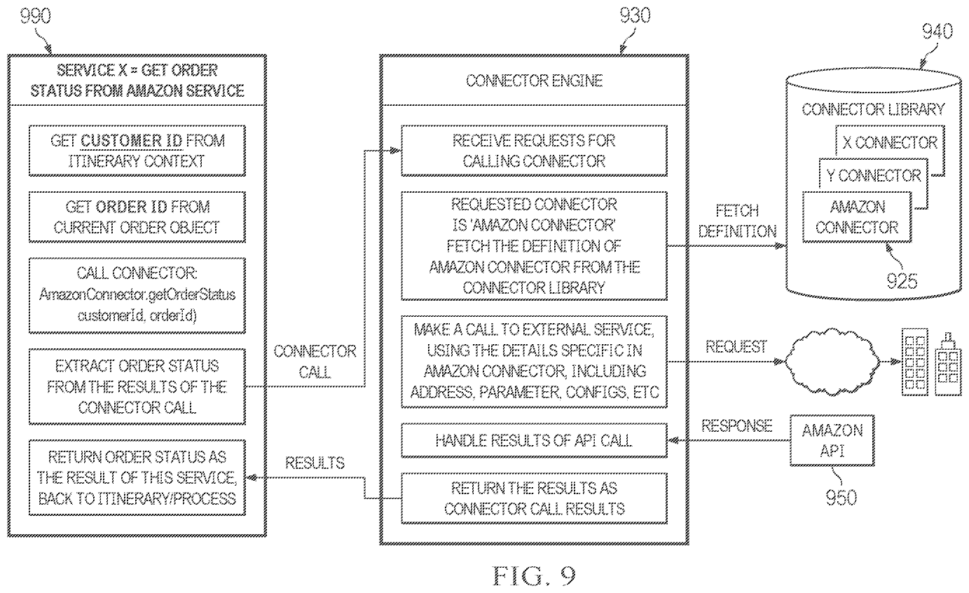

As illustrated in FIG. 9, the universal service (e.g., Service X 990) is operable to obtain a customer ID from the target itinerary, obtain an Order ID from the corresponding Order object, call (via the connector engine) the appropriate external service with the customer ID and the Order ID, and extract the order status from the results of the connector call. The connector engine (e.g., connector engine 930) receives the request for calling the external service, determines the API connector for the requested external service, fetches details (e.g., API connector or connector definition 925) of the requested external service from the connector library (e.g., connector library 940), and makes the actual API call to the external service (e.g., third-party API 950) using the details specified in the API connector, including the address, parameter(s), configuration, etc. for making the API call to the service-provider system. The connector engine also handles the results of the API call and returns the results to the universal service which, in turn, returns the order status as a result of the external service. At this point, control is returned back to the itinerary and processing of the itinerary continues (e.g., calling a managed service according to the itinerary).

Through the A2A integration framework that includes an ingress router, a connector system, and enhancements to an orchestration service framework such as the universal service, any orchestration service managed by the information exchange platform can make a call to the connector engine for running a specified API connector to a third-party service provider system, allowing the orchestration service of the information exchange platform to seamlessly integrate with the API connectors published in the connector database. This streamlined process can alleviate technical challenges in third-party service integration efforts and, therefore, can scale well as the number of third-party service provider systems increases.

The inventive subject matter, in some embodiments, is directed to computer and machine-driven architectures, methodologies, and techniques for generating an API connector (also known as a service connector) for an external service called from within an orchestration engine which transacts services including the external service. The orchestration engine is designed to call a set of services, collectively referred to as an itinerary, to process and perform a set of actions. There are many different examples of actions and scenarios handled by itineraries, such as, but not limited to, processing a customer order in which the order is sent to a supplier, which invokes a request to a manufacturer to fulfill the order, issues an invoice, expedites delivery of the order to the customer, and also facilitates payment between and among the participants (i.e., those who transact in the itinerary).

The orchestration engine processes the set of services in an itinerary sent as a request by a customer, either directly or through another party or application. The orchestration engine receives the itinerary and processes and performs the set of services included therein. In a non-limiting example, the set of services comprises a service which receives a compressed order object, decompresses the object and passes the result to another service which decrypts the decompressed object. Next, a further service parses the object and sets off a series of other services (which may be called sub-services) which translate the object into different formats for further processing. Yet another service reads the cumulative results and issues an order to a vendor system via an external service under the control of a vendor (this requires that the orchestration engine pass to the external service a set of inputs required by the external service and that the orchestration properly handle returned results, if any).

Vendors often modify their services to add new features and functions. The orchestration engine must monitor such modifications for any changes in input requirements, addresses and other updates for the external service. The orchestration engine must then properly adjust to these modifications to call the updated external service. In fact, changes to external services could disable the orchestration engine and therefore cause itineraries to fail, unless the orchestration engine makes the proper adjustments in a timely fashion. In the past, changes to the external service required that every itinerary (executed by the orchestration engine) accessing the external service be modified to adjust to the changes. At times, this resulted in significant additional cost, time, and effort of programmers who design and maintain the itineraries.

Advantageously, as will be further explained below, the inventive subject matter enables the generation of API connectors that the itineraries may call to access external services. Essentially, if an external service is modified (such as by the vendor), only a single API connector designed to operate with the external service needs to be updated and called by every itinerary using the external service. More generally, the “write-once run-everywhere” capability of the inventive subject matter greatly facilitates the use and incorporation of external services with more flexibility and agility and results in significant savings in programmer cost, time, and effort. Another net benefit is that orchestration engines may greatly expand their operational capability by more easily incorporating existing services (which inevitably change over time) using API connectors.

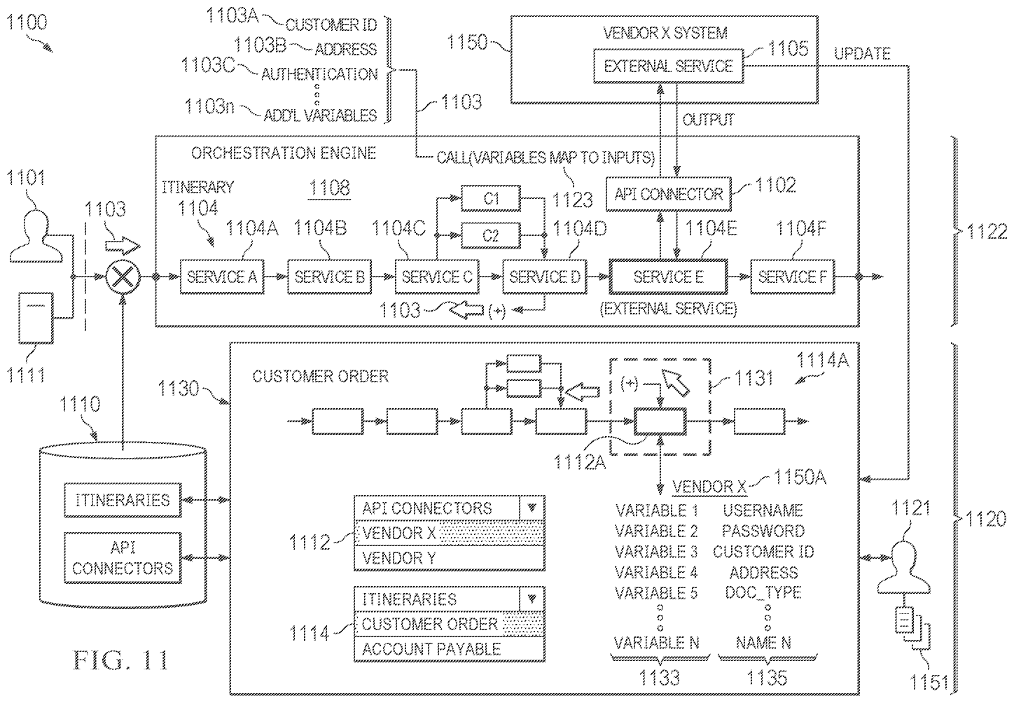

Referring now to FIG. 11, a non-limiting embodiment of the inventive subject matter is directed to system 1100 for generating an API connector 1102 for an external service 1105 called by an orchestration engine 1108. Referring again to the non-limiting example described above, a set of services may be generated as an itinerary 1104 for completing a customer order. As shown in FIG. 11, itinerary 1104 is issued by a customer 1101 and/or may be set off by an automated process or application 1111 that calls itinerary 1104. Itinerary 1104 may be retrieved from a storage, such as (but limited to) database 1110 and, in some embodiments, itinerary 1104 may include a unique identifier to find and load it from database 1110 and/or other resources. Itinerary 1104 includes a set of services which may be defined to operate sequentially and/or in parallel, setting off other services to perform operations and relink to services further on down the chain. The orchestration engine 1108 may then transact the set of services in the itinerary 1104.

In one example for illustrative purposes and not intended to limit the scope of the inventive subject matter, service A (1104A) receives a compressed order object and decompresses the order object. Service A (1104A) sends the result to service B (1104B) which decrypts the decompressed object. Next, service C (1104C) parses the object and sets off a series of other services C1 and C2 which translate the object into different formats for further processing. The cumulative translation results from C1 and C2 are passed to service D (1104D) which issues an order to a vendor via external service call. Here, the customer order itinerary 1104 requires external service 1105 because the customer (more particularly, orchestration engine 1108) leverages a vendor system 1150 to accept, process, and complete orders. External service call 1104E issues a request to the vendor system 1150 and receives a result which it then passes to service F 1104F, and so on. In this way, the orchestration engine 1108 may leverage a wide variety of existing external services, without having to duplicate the functionality (not to mention expertise, experience, and resources) offered by the vendor system 1150.

Moreover, external service call 1104E uses API connector 1102 to call the external service 1105. The API connector 1102 passes variables 1103 to the external service 1105, which may be mapped to a set of inputs 1123, and data values as defined by the external service 1105. In some embodiments, the API connector 1102 passes a customer identifier 1103A (of the customer issuing the order) to the external service 1105, which uses the customer identifier 1103A to map to a vendor identifier to find the customer order. In further embodiments, an address 11038 of the external service is passed to the orchestration engine 1108, which is passed to the API connector 1102 to look up and access the external service (such as an https address or an API key for the external service). In the same or a different embodiment, authentication information 1103C (such as for a customer, an application, or an account user of external service 1105) is passed to the orchestration engine 1108 (or the orchestration engine may look up the authentication information) so that the API connector 1102 can authenticate access to the external service 1105.

Furthermore, the external service 1105 may be described by documentation that describes the inputs 1123 needed by the external service 1105 to process orders. Such inputs 1123 are required to, for example, look up the customer in the vendor system 1150, process an object type used to represent orders, and/or to perform other vendor system functions. The API connector 1102 is generated to include a set of variables 1103 which are mapped to inputs 1123 of the external service 1105. Once the API connector 1102 accesses the external service 1105 (via address 1103B), authenticates (if needed, via authentication information 1103C) with the external service, and passes any additionally needed variables 1103N as inputs, the API connector 1102 may then be used to call and execute functionality of the external service 1105.

The API connector 1102 receives a response (or set of responses to calls) from the external service 1105 and may then pass the response to the orchestration engine 1108 for processing, such as by another services (such as service F 1104F) in the itinerary 1104.

In further embodiments, API connector 1102 is updated for external service 1105 and stored in storage, such as in storage 1110. The updated API connector may then be regenerated in itineraries that use the external service 1105, such as itinerary 1104. In still further embodiments, when an external service is modified, such as by vendor system 1150, a notification regarding the modification (which may include documentation on the modification) prompts the redesign and regeneration of API connector 1102. Thus, instead of requiring that every separate call to the external service 1105 be rewritten in every itinerary to adjust to the modification, only the API connector need be rewritten and then accesses by every itinerary using the external service 1105. As explained above, this write-once run-anywhere methodology for updating communications with external services is flexible and agile and can result in significant savings in programmer cost, time, and resources.

In some embodiments, system 1100 has a design component 1120 and a runtime component 1122. The design component 1120 has a capability to generate API connectors (such as API connector 1102) to call external services (such as external service 1105 of vendor system 1150). Documentation 1151 for the external services may be used to build API connectors, including defining a set of variables (such as variables 1103) for API connectors passed as input (such as input 1123) to calls to external services. API connectors once generated, may be stored in storages (such as database 1110) so that they may be added to and called in itineraries (such as itinerary 1104 stored in database 1110) including a set of services to be transacted by orchestration engines. The design component 1120 facilitates the definition of variables (such as variables 1133) and variable names (such as variable names 1135) for API connectors. At runtime, variables will be instantiated (and defined in some embodiments in a variable data structure) and passed by API connectors to external services, which in some cases may be mapped to the required inputs (such as inputs 1123) to perform external service functions.

As shown on FIG. 11, an external service may be updated, which in some embodiments produces a notification (represented by the “A” with a circle around it) to regenerate a corresponding API connector to resave and reincorporate into the set of services in itineraries.

As can further be seen in FIG. 11, designers and programmers 1121 may user interface 1130 to view, edit, and save itineraries x14 and API connectors 1112, including building and generating variables for API connectors. In the non-limiting example of user interface 1130, a programmer 1121 has added/inserted selected API connector 1112A for an external service of “VENDOR 11” 1150A to selected itinerary 1114A (called “CUSTOMER ORDER”) and defines variables 1133 and variable names 1135 as inputs to the external service. The programmer and/or designer 1121 can add the API connector 1112A by inserting it (via direction manipulation of an icon for API connector 12A, as designated by reference numeral 1131) into itinerary 1114A.

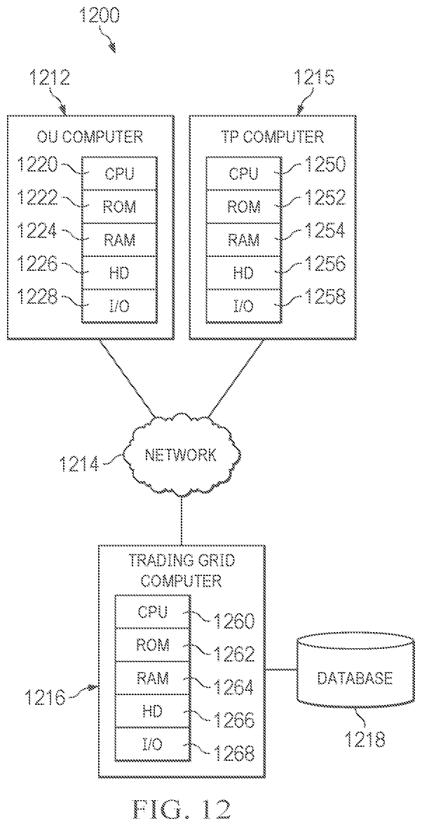

FIG. 12 depicts a diagrammatic representation of a distributed network computing environment where embodiments disclosed can be implemented. In the example illustrated, network computing environment 1200 includes network 1214 that can be bi-directionally coupled to first enterprise computer 1212, second enterprise computer 1215, and Trading Grid computer 1216. Trading Grid computer 1216 can be bi-directionally coupled to data store 1218. Network 1214 may represent a combination of wired and wireless networks that network computing environment 1200 may utilize for various types of network communications known to those skilled in the art.

For the purpose of illustration, a single system is shown for each of first enterprise computer 1212, second enterprise computer 1215, and Trading Grid computer 1216. However, with each of first enterprise computer 1212, second enterprise computer 1215, and Trading Grid computer 1216, a plurality of computers (not shown) may be interconnected to each other over network 1214. For example, a plurality of first enterprise computers 1212 and a plurality of second enterprise computers 1215 may be coupled to network 1214. Each of enterprise computers 1212, 1215 may include data processing systems for communicating with Trading Grid computer 1216.

Enterprise computer 1212 can include central processing unit (“CPU”) 1220, read-only memory (“ROM”) 1222, random access memory (“RAM”) 1224, hard drive (“HD”) or storage memory 1226, and input/output device(s) (“I/O”) 1228. I/O 1229 can include a keyboard, monitor, printer, electronic pointing device (e.g., mouse, trackball, stylus, etc.), or the like. Further, enterprise computer 1212 can include a desktop computer, a laptop computer, a personal digital assistant, a cellular phone, or nearly any device capable of communicating over a network. Likewise, enterprise computer 1215 can comprise CPU 1250, ROM 1252, RAM 1254, HD 1256, and I/O 1258.

Similarly, Trading Grid computer 1216 may include CPU 1260, ROM 1262, RAM 1264, HD 1266, and I/O 1268. Trading Grid computer 1216 may include one or more backend systems configured for providing a variety of services to first enterprise computers 1212 over network 1214. These services may utilize data stored in data store 1218. Many other alternative configurations are possible and known to skilled artisans.

Each of the computers in FIG. 12 may have more than one CPU, ROM, RAM, HD, I/O, or other hardware components. For the sake of brevity, each computer is illustrated as having one of each of the hardware components, even if more than one is used. Each of computers 1212, 1215, and 1216 is an example of a data processing system. ROM 1222, 1252, and 1262; RAM 1224, 1254, and 1264; HD 1226, 1256, and 1266; and data store 1218 can include media that can be read by CPU 1220, 1250, or 1260. Therefore, these types of memories include non-transitory computer-readable storage media. These memories may be internal or external to computers 1212, 1215, or 1216.

Portions of the methods described herein may be implemented in suitable software code that may reside within ROM 1222, 1252, or 1262; RAM 1224, 1254, or 1264; or HD 1226, 1256, or 1266. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved by distributed or networked systems. Communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

Although the foregoing specification describes specific embodiments, numerous changes in the details of the embodiments disclosed herein and additional embodiments will be apparent to, and may be made by, persons of ordinary skill in the art having reference to this disclosure. In this context, the specification and figures are to be regarded in an illustrative rather than a restrictive sense, and all such modifications are intended to be included within the scope of this disclosure. The scope of the present disclosure should be determined by the following claims and their legal equivalents.

What is claimed is:

1. A method for generating an application programming interface connector for an external service called by an orchestration service engine, the method comprising:
generating an application programming interface connector for an external service, the application programming interface (API) connector comprising a call to the external service and comprising a customer identifier for a customer associated with the external service;
storing in a storage the API connector for the external service;
generating a set of services to transact on an orchestration engine, one of the set of services comprising the API connector for the external service retrieved from the storage;
receiving, at the orchestration service engine, a request to transact the set of services;
transacting the set of services including transacting the external service, comprising;
calling the API connector comprising passing to the external service a value for the customer identifier;
receiving a response from the external service, the response based on the customer identifier; and
passing the response to the orchestration engine for processing by the orchestration engine.

2. The method of claim 1, wherein a set of variables input to the API connector comprises an address of the external service and authentication information for the external service and wherein transacting the set of services including transacting the external service further comprises:
calling the external service at the address of the external service; and
authenticating on the external service using the authentication information.

3. The method of claim 2, wherein the address of the external service comprises an address of an API of the external service and wherein calling the external service at the address of the external service further comprises:
calling the API of the external service at the address of the API.

4. The method of claim 1, wherein the API connector further comprises a set of input variables including the customer identifier and wherein calling the API connector comprising passing to the external service the value for the customer identifier further comprises:
passing to the external service other values for the set of variables and matching the values to inputs for the external service.

5. The method of claim 1, further comprising:
updating the API connector for the external service;
storing in the storage the updated API connector for the external service; and
regenerating the set of services to transact on the orchestration engine including retrieving the updated API connector for the external service from the storage.

6. The method of claim 5, wherein updating the API connector for the external service is in response to receiving a notification that the external service has been updated.

7. The method of claim 1, wherein the API connector further comprises a set of input variables including the customer identifier, the customer identifier passed directly into the orchestration engine and forwarded to the API connector and one or more other services transacted by the orchestration engine generate and pass at least one other value in the set of input variables to the API connector.

8. A system for generating an application programming interface connector for an external service called by an orchestration service engine, the system comprising:
a processor;
a non-transitory computer-readable medium; and
instructions stored on the non-transitory computer-readable medium and translatable by the processor for:
generating an application programming interface connector for an external service, the application programming interface (API) connector comprising a call to the external service and comprising a customer identifier for a customer associated with the external service;
storing in a storage the API connector for the external service;
generating a set of services to transact on an orchestration engine, one of the set of services comprising the API connector for the external service retrieved from the storage;
receiving, at the orchestration service engine, a request to transact the set of services;
transacting the set of services including transacting the external service, comprising;
calling the API connector comprising passing to the external service a value for the customer identifier;
receiving a response from the external service, the response based on the customer identifier; and
passing the response to the orchestration engine for processing by the orchestration engine.

9. The system of claim 8, wherein a set of variables input to the API connector comprises an address of the external service and authentication information for the external service and wherein transacting the set of services including transacting the external service further comprises:
calling the external service at the address of the external service; and
authenticating on the external service using the authentication information.

10. The system of claim 9, wherein the address of the external service comprises an address of an API of the external service and wherein calling the external service at the address of the external service further comprises:
calling the API of the external service at the address of the API.

11. The system of claim 8, wherein the API connector further comprises a set of input variables including the customer identifier and wherein calling the API connector comprising passing to the external service the value for the customer identifier further comprises:
passing to the external service other values for the set of variables and matching the values to inputs for the external service.

12. The system of claim 8, wherein the instructions are further translatable by the processor for:
updating the API connector for the external service;
storing in the storage the updated API connector for the external service; and
regenerating the set of services to transact on the orchestration engine including retrieving the updated API connector for the external service from the storage.

13. The system of claim 13, wherein updating the API connector for the external service is in response to receiving a notification that the external service has been updated.

14. The system of claim 8, wherein the API connector further comprises a set of input variables including the customer identifier, the customer identifier passed directly into the orchestration engine and forwarded to the API connector and one or more other services transacted by the orchestration engine generate and pass at least one other value in the set of input variables to the API connector.

15. A computer program product comprising a non-transitory computer-readable medium storing instructions for generating an application programming interface connector for an external service called by an orchestration service engine, the instructions translatable by a processor for:
generating an application programming interface connector for an external service, the application programming interface (API) connector comprising a call to the external service and comprising a customer identifier for a customer associated with the external service;
storing in a storage the API connector for the external service;
generating a set of services to transact on an orchestration engine, one of the set of services comprising the API connector for the external service retrieved from the storage;
receiving, at the orchestration service engine, a request to transact the set of services;
transacting the set of services including transacting the external service, comprising:
calling the API connector comprising passing to the external service a value for the customer identifier;
receiving a response from the external service, the response based on the customer identifier; and
passing the response to the orchestration engine for processing by the orchestration engine.

16. The computer program product of claim 15, wherein a set of variables input to the API connector comprises an address of the external service and authentication information for the external service and wherein transacting the set of services including transacting the external service further comprises:
calling the external service at the address of the external service; and
authenticating on the external service using the authentication information.

17. The computer program product of claim 16, wherein the address of the external service comprises an address of an API of the external service and wherein calling the external service at the address of the external service further comprises:
calling the API of the external service at the address of the API.

18. The computer program product of claim 15, wherein the API connector further comprises a set of input variables including the customer identifier and wherein calling the API connector comprising passing to the external service the value for the customer identifier further comprises:
passing to the external service other values for the set of variables and matching the values to inputs for the external service.

19. The computer program product of claim 15, wherein the instructions are further translatable by the processor for:
updating the API connector for the external service;
storing in the storage the updated API connector for the external service; and
regenerating the set of services to transact on the orchestration engine including retrieving the updated API connector for the external service from the storage.

20. The computer program product of claim 15, wherein the API connector further comprises a set of input variables including the customer identifier, the customer identifier passed directly into the orchestration engine and forwarded to the API connector and one or more other services transacted by the orchestration engine generate and pass at least one other value in the set of input variables to the API connector.
